(19) United States
(12) Patent Application Publication
(10) Pub. No.: US 2009/0190187 A1
(43) Pub. Date: Jul. 30, 2009

(54) PRINT SYSTEM WITH DETECTION SYSTEM AND METHOD

(75) Inventors: David J. Cornell, Scottsville, NY (US); Joseph A. Manico, Rochester, NY (US)

Correspondence Address: David A. Novais, Patent Legal Staff;Eastman Kodak Company, 343 State Street, Rochester, NY, 14650-2201, US

(73) Assignee: Eastman Kodak Company

(21) Appl. No.: 12/022,360

(22) Filed: Jan. 30, 2008

(51) Int. Cl. H04N 1/04

(52) U.S. Cl. 358/474

(57) ABSTRACT

A print system with scanner with diagnostic system including one or more image capture modules mounted in a body, such that the imaging modules scan a diagnostic area around the print mechanisms to capture a representative image of said diagnostic area. The one or more image capture modules mounted in the body in fixed relation to the diagnostic area being operative to capture a stream of the representative images of the diagnostic area in order to generate output leading to recommended corrective actions.

### FIELD OF THE INVENTION

The invention relates to a print system and more particularly relates to a print system including a scanner with one or more image capture modules being operative to include a diagnostic system and related method.

### BACKGROUND OF THE INVENTION

Document print systems with scanners have become a popular computing accessory both in the home and the office. Essentially, document print system with scanners (or simply “print system with scanners” or “All in one print systems”) come in three distinct varieties of scanners including a sheet-fed print system, platen print system and print systems having a rigid combination of sheet-fed and platen scanning capabilities. With respect to one type of all in one print system, an image-forming subsystem typically including a linear imaging sensor and a lens in combination with an illumination source, scans an image by moving a sheet of paper past the sensor, which sits in a stationary position. The documents are fed from a stack and are passed through a paper path disposed at the field of view of the sensor. As each document passes in front of the sensor individual raster lines are imaged by the imaging device and then pieced together to create a 2D image representation of the original document. The imaging device captures the width of the image, line by line, while the document is moved past the sensor.

With respect to another all in one print systems having a platen, a document is placed face down onto a stationary flat transparent surface of the print system and the image-forming subsystem and illumination source, moves underneath the fixed document to perform the scanning operation. In this case, the imaging device is moved the length of the document while the optics cover the width of the scanned document. The platen print system requires lifting a lid and placing document sheets face down one at a time. The platen capability is also employed to deal with documents that do not feed from a stack reliably.

Print systems and Scanners vary in speed, function, and cost and are often used by businesses for scanning large quantities of documents. The demand for scanning at a given installation can be as high as from several hundred (100) to several hundred thousand (100,000) pages per day. One type of all in one print system with scanner attempts to combine the functionality of a sheet-fed print system with scanner with that of a platen print system with scanner. Essentially, such combination production print system with scanners are manufactured as a single unit that combine the platen scanning functions with the sheet moving functions in a single box.

With prior sheet-fed, platen, or combination print system with scanners, the user must select one type in favor of another. For those customers whose primary need is for a sheet-fed print system with scanner but who occasionally need the platen utility, they must purchase a combination device or two separate print system with scanners (one sheet-fed and one platen). One task may require scanning a large number of similar documents, suited to the sheet-fed print system with scanner and not requiring a platen. The next task at the next site may require scanning fragile documents or books, requiring the use of a platen. Thus, portability and the ability to reconfigure and perform multiple scanning functions are critical to people who buy print system with scanners to scan documents as a service. Thus new print system with scanners of this type that can operate independently from the computer when used as a component for an “all-in-one” device also incorporating a printer and modem to provide copying and faxing capabilities have become popular. However, print systems with a scanner of this type typically have many more working parts and thus are more complicated and subject to problems.

Adding to the difficulty are the number of functions new all in one printers are asked to perform. Print system with scanners are asked to accommodate different sizes of “flat art” including images, documents, artwork, and the like. When scanning documents that are larger that the scan aperture, it is known to use “digital stitching algorithms” to combine multiple overlapping sections of an image into a complete seamless digital image. Because many images are recorded on tangible mediums that are stored in photo albums with image bearing mediums adhered to pages with many different techniques using glues, adhesives, and tapes, removal of these image bearing mediums from the photo albums would be labor intensive, time consuming, and could subject fragile, one of a kind, images to potential damage. Since photo albums typically are formed by bound pages it would not be possible to scan these pages with a smaller format print system with an incorporated print feed mechanism. In addition, when attempting to scan bound albums with a typical flat bed print system with scanner, damage to the binder, binding means, and/or book spine could occur when pressing an opened album against the scan aperture. Finally, transporting a large format document print system with scanner, that is not capable of operating independently from a computer, to an event such as a family holiday celebration in order to copy images from a bound photo album would be difficult if not impractical.

All in one print systems that can perform all these tasks with different types of paper and sizes and types of receivers typically have many more working parts and thus are more complicated and subject to many different problems. Examples possible problems are paper jams and hot offset as well as partial and multiple paper feeds and other problems that are difficult to detect early in a print cycle and thus are difficult to correct without damaging the document or the machine. This is important because a print system with a scanner is increasingly being used to digitize old, fragile and rare documents. Similarly parts of the scanner may get jammed or malfunction due to a misuse of the printer or incompatible receivers. These difficult situations are becoming much more common in these days of speed scanning. Prior art print system with scanners may have a preview function but that does not actually show you the problem in real time.

It is desirable to have a print system and related methods of printing that correct these problems by using a detection system.

### SUMMARY OF THE INVENTION

The invention, in broader aspects, provides a body and one or more print mechanisms disposed in said body wherein a diagnostic area corresponds to an area around said print mechanism. The invention also includes one or more image capture modules disposed in said body facing respective portions of said one or more diagnostic areas, each said image capture module capable of generating a stream of images in order to provide diagnostics and such as detection and correction of any print related problems during printing.

### BRIEF DESCRIPTION OF THE DRAWINGS

The invention and its objects and advantages will become apparent upon reading the following detailed description and upon reference to the drawings.

FIGS. 1-3 are perspective views of a prior art sheet-fed, platen, and combination print system.

FIG. 4 is a perspective view of a print system with diagnostic system according to the present invention.

FIG. 5 shows detail of the print system with diagnostic system according to the present invention.

FIG. 6 is a schematic side view, showing details of the internal mechanisms of the diagnostic system.

FIG. 7 shows a portion of an embodiment of the diagnostic system.

FIG. 8 is an embodiment of the diagnostic system.

FIG. 9 shows the steps for a method of using the print system with diagnostic system.

### DETAILED DESCRIPTION OF THE INVENTION

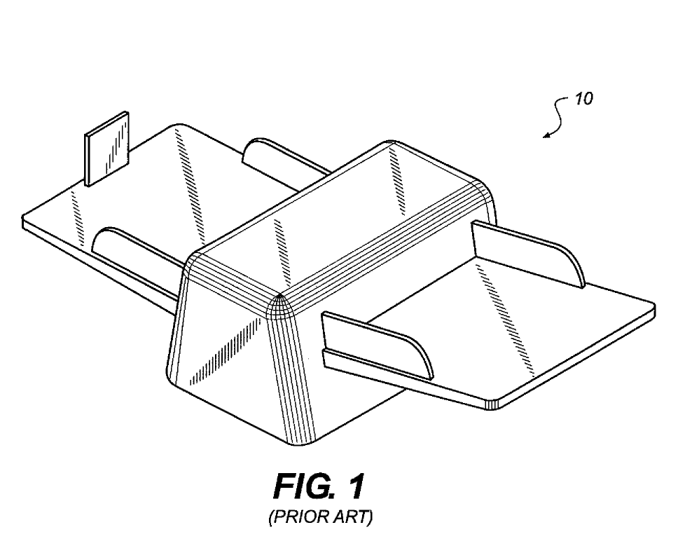

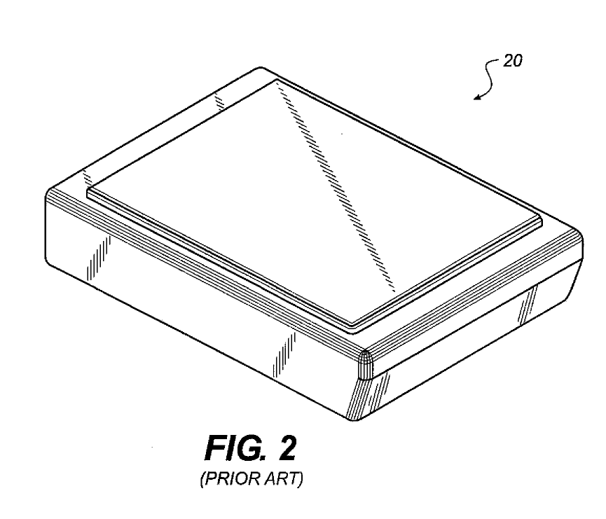

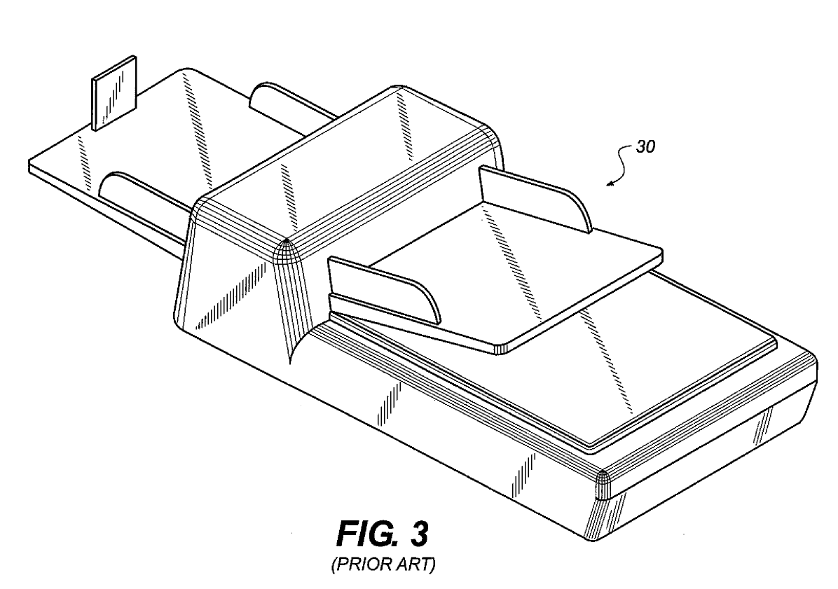

Essentially, all in one document print system (or simply “print system with scanners”) come with a scanner in one of three distinct varieties: sheet-fed scanners 10 as shown in FIG. 1, platen scanners 20 shown in FIG. 2, and scanners 30 having a rigid combination of sheet-fed and platen scanning capabilities shown in FIG. 3. With respect to sheet-fed scanners 10, an image-forming subsystem, such as a printer, camera, phone and entertainment device, typically including a linear imaging sensor and a lens in combination with an illumination source, scans an image by moving a sheet of paper past the sensor, which sits in a stationary position. The documents are fed from a stack and are passed through a paper path disposed at the field of view of the sensor. As each document passes in front of the sensor individual raster lines are imaged by the imaging device and then pieced together to create a 2D image representation of the original document. The imaging device captures the width of the image, line by line, while the document is moved past the sensor.

With respect to platen scanners 20, a document is placed face down onto a stationary flat transparent surface of the scanning unit and the image-forming subsystem and illumination source, moves underneath the fixed document to perform the scanning operation. In this case, the device is moved the length of the document while the optics cover the width of the scanned document. The platen scanner requires lifting a lid and placing document sheets face down one at a time. The platen capability is also employed to deal with documents that do not feed from a stack reliably.

All in one print system with scanners that combine the above types of scanners vary in speed, function, and cost and are often used by businesses for scanning large quantities of documents. The demand for scanning at a given installation can be as high as from several hundred (100) to several hundred thousand (100,000) pages per day. Sheet-fed print systems with scanners offer greatest productivity by employing an imaging system on both sides of the paper path, imaging both the front and back of each document during the same scanning operation. One type of scanner 30 that could be incorporated into a printer by adding a print engine attempts to combine the functionality of a sheet-fed print system with scanner with that of a platen print system with scanner. Essentially, such combination production print system with scanners are manufactured as a single unit that combine the platen scanning functions with the sheet moving functions in a single box.

Since printer speeds today are so fast, exceeding 30 color pages a minute in small desktop devices, early intervention when a printing error occurs can be crucial to maintaining a reasonable Total Cost of Ownership (TCO). Printing errors such as damaged paper, paper jams, fuser offset improper fusing, low toner, skew errors, duplex errors, scale, layout errors and the like if not rapidly detected can produce a large volume of prints that will unusable requiring that they be disposed, corrected, and re-printed. When a user is using an all in one printer a part of the document may not be physically in the scanned area or items must be physically reconfigured and cause problems. Similarly parts of the printer may get jammed or malfunction due to a misuse of the printer or incompatible receivers. These difficult situations are becoming much more common in these days of speed scanning.

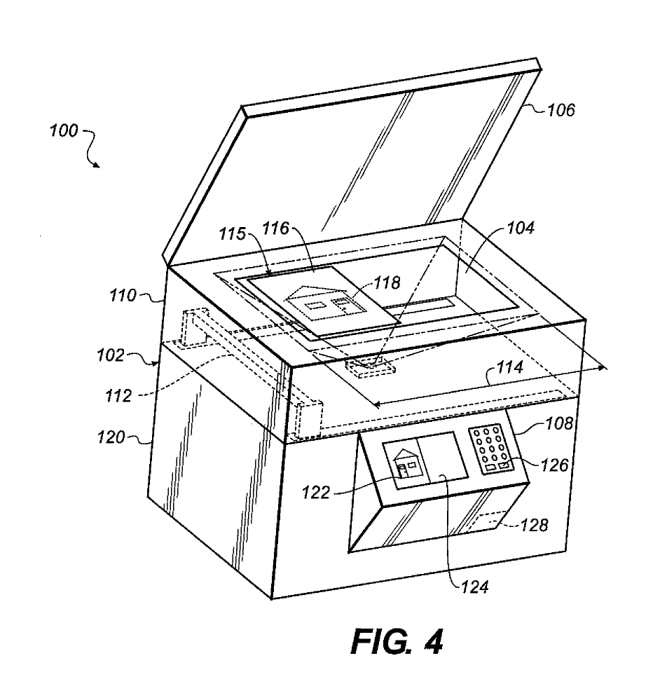

FIG. 4 shows an all-in one printer with diagnostic system 100 and related methods of diagnostics that can solve these problems. The printer with diagnostic system 100 includes a body 102, a platen 104 held by the body 102, and an optional lid 106. The system 100 has a diagnostic viewing module 108 mounted on the body as well as a scanning module 110 mounted below the platen. The scanning module 110 has an image forming subsystem, such as a linear imager 112. The linear imager being translatable relative to the platen 104 wherein, in this embodiment, the platen defines a capture zone 114 of an item or items 115, such as a document 116 having an image 118 before print engine 120 prints an item. When portions of the item are not positioned properly or ha mechanism malfunctions, such as misfeeding a receiver a malfunctioning roller, the print engine 120 does not printing properly and a diagnostic system 130 allows that mechanism to be viewed real time. The diagnostic system allows detection of the problem by use of a representative image 122 and/or other data. The diagnostic images are usually representative images that are collected over time or due to a signal and can be non-archival or archival, and can be used to correct the problem or potential problem using the diagnostic system 130 during printing without the worries that unseen problems can produce. The image can also be a differential, either historical or current between one or more mechanisms. The representative images can be compared to one or more references 155 to show a change over time that might be to gradual to notice, such as a toner color change or slight image shift that would lead to a skewed print. In that case the reference might be an image. The diagnostic system 130 can also reference a line or standard reading, such as temperature to determine the potential for a problem based on stored information, such as past operating conditions.

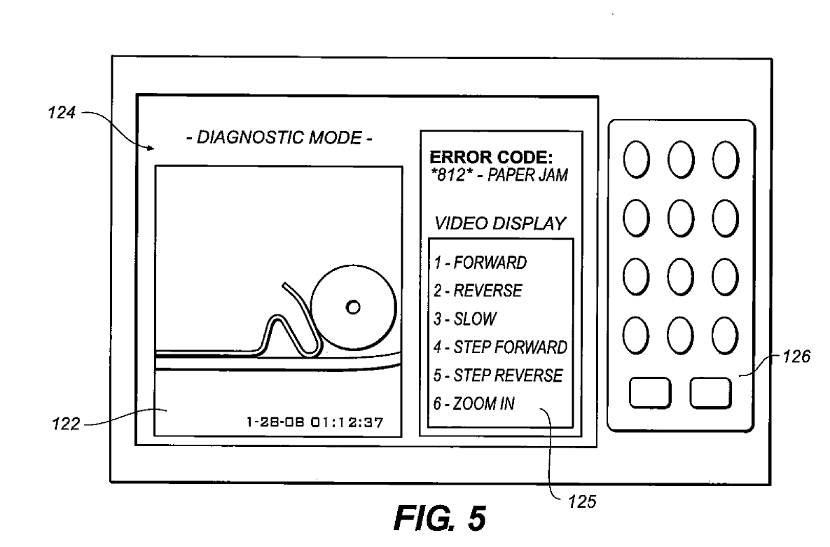

The representative image 122 can be displayed on the printer system as part of a display screen 124, such as an LCD screen, that is shown as part of the diagnostic viewing module 108 in communication with the system 100 and shown in FIG. 5 as mounted on the body of the printer. This display could be connected in a wired or wireless configuration adjacent to or remote from the printer body 102. This allows a user or controller access to a live picture of what is in the system 100 as well as other diagnostic information in real time so that problems can be corrected real time and printer lost time avoided. This system can be accessed via an input device 126, shown in FIG. 4 as a keypad. The user input system 126 or other device is capable of receiving an input from a user and converting this input into a form that can be used by a processor in a control unit 128. For example, user input system 126 can comprise a touch screen input, a touch pad input, a 4-way switch, a 6-way switch, an 8-way switch, a stylus system, a trackball system, a joystick system a voice recognition system, a gesture recognition system or other such systems. In the embodiment illustrated in FIG. 4 the user input system 126 includes a keypad or keyboard for receiving input from a user. The display 124 is connected to the control unit 128 and provides information to a user so that the user can interact with printer 120 and diagnostic printer system 100. Various components of user input system 126 and/or display 124 can be located within housing or can be separate there from. Where separate, user input system 126 and display 124 can exchange signals with the control unit 128 by way of wired or wireless signals and connections.

### Scanning Unit

The scanning unit 110, also referred to as a scanning module, is located in the upper portion of the body 102, also referred to as a housing or cabinet that can house the upper scanning module 110 and the lower printer engine or module 120. The upper portion of the body 102 includes the platen 104 shown here as a transparent (e.g. glass) plate upon which the item 115, such as a document 116 having the image 118 as shown in FIG. 4, is placed in a face-down position. The glass platen 104 is where documents will be placed in relation to the image forming subsystem, such as the linear imager 112 shown in FIG. 4. Note; the scanning unit need not be physically connected to the printer. It may be connected to the printer via a wired, wireless, and/or network connection.

It is known that these scanning modules could be arranged in other configurations that are known in the art to cooperate to scan and print an item. In this embodiment, the glass top or platen 104 provides the place where documents to be scanned are placed. The optional lid 106 allows covering of the documents to be scanned, and limits the outside influence of lights, which would interfere with proper scanning of a document as well as helps to hold any item flat against platen 104. The lid 106 is attached by a hinge or in another appropriate manner or may be just a lift able separate part.

The printer with diagnostic system provides a housing for the various components, devices, subsystems, and other mechanisms necessary to effectuate scanning of documents. Prior to scanning, the lid 106 may be closed to provide the proper lighting, background, and paper constraint conditions for the image-forming subsystem 112 and, in particular, to permit the optical system, including any lens, to receive adequate light reflections of images appearing on documents placed on platen 104. The scanning unit 110 includes a set of mechanisms for enabling complete platen scanning of documents in operable combination with the control and image processing functions. The platen element includes an enclosure having a top surface with a glass top attached thereon. The platen element can include a lid with a substantially flat surface suitable for covering documents placed on the glass top. The lid can be opened and closed with a hinging means that couples the lid to the enclosure.

### Diagnostic System Unit

The lower portion of the body 102 encloses the lower printer engine or module 120 that houses mechanisms 158 necessary to effect printing as well as housing the diagnostic system 130 and controller 128. These modules and mechanisms could be arranged in various configurations to cooperate to diagnose a problem and may have specific printer mechanisms identification indicators (ids) 135 to facilitate the monitoring. In this embodiment, the glass top or platen 104 provides the place where documents to be scanned are placed. The optional lid 106 allows covering of the documents to be scanned, and limits the outside influence of lights, which would interfere with proper scanning of a document as well as helps to hold any item flat against platen 104. The lid 106 is attached by a hinge or in another appropriate manner or may be just a lift able separate part. The diagnostic system 130 provides various components, devices, subsystems, and other mechanisms necessary to effectuate print diagnostics.

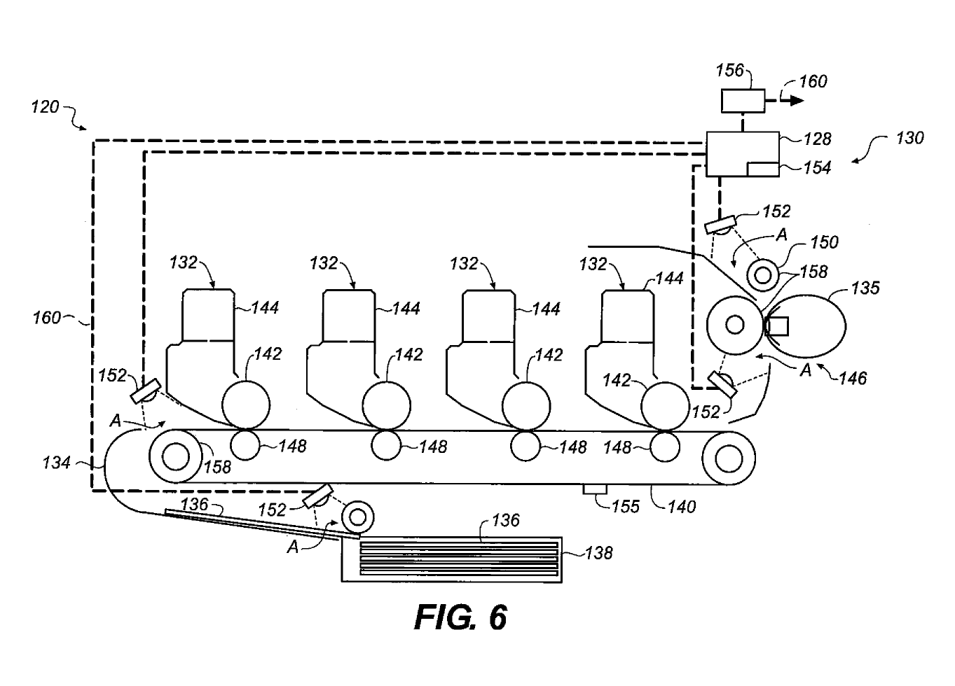

FIG. 6 shows a portion of the printer with diagnostic system including one or more print engines, a paper path that supplies receivers 136, also referred to as media, from a media supply 138 to a transport belt 128. The transport belt transports the receiver 136 past the printing stations including an imaging system 142 and toner system 144 to a fusing system 146 past one or more rollers 148, including an exit roller 150 all, along with any other operating parts of a printer, referred to collectively as print mechanisms 158. Other examples of print mechanisms include, but are not limited to, media picking motors, exit roller motors, media urge roller motors, transport belt stepper motors, print-station engagement motors, fuse roller motors and solenoid controlled media path diverters as well as toner supply systems and any printer related systems such as glossers, book binders, and other finishing devices.

The diagnostic system 130 includes one or more diagnostic image capture modules 152 disposed in operative relation to at least one of the print mechanisms 158 that is surrounded by a diagnostic area A corresponds to an area around one or more print mechanisms. The one or more image capture modules 152 are disposed in the printer facing respective portions of said one or more diagnostic areas such that each image capture module 152 is capable of generating a stream of images to memory 154 in the control unit, shown here as representative memory. An image capture controller 156 is shown here in communication with the control unit 128 for controlling the image capture modules 152 in relation to predetermined references 155. The control unit 156 is responsive to a control signal 160 and instructions, such as user or controller generated instructions via the control unit 128 for initiating operation of the image capture modules 152 in relation to the references 155 using the image capture controller 156 to deliver information such as video combined with diagnostic information that can be collected from the printer and surrounding area and associated uses. This information includes but is not limited to the room and printer temperatures, the print mode, the user, the receiver and other print related information. The diagnostic information in a video format can be delivered at a rate commensurate with normal operation of the printing system to the memory. The diagnostic system 130 contains subsystems plus additional systems for communicating to a host computer, the hardware and firmware for processing and transmitting the diagnostic images and any necessary controllers, etc.

The image capture modules can also use references 155 that are reference images or views that may detect a build up of dust, debris, escaped toner particles, paper fibers, and the like. Also by making comparisons to reference images the changes in conditions can be used to suggest maintenance procedures or corrective actions. Examples, if a rapid build up of yellow toner is observed the system could alert the user to check to verify that the yellow toner cartridge is properly seated. If a build up of paper fibers and dust is detected the system could request that the user vacuum out the unit and clean the drive rollers with isopropyl alcohol.

The reference images can be stored in memory and used by the image capture modules to detect changes over time. Reference images can be created using the image capture modules in a calibration mode at the factory or during the initial setup procedure. To conserve memory and computational resources images can be converted into histograms and only differences between reference images and subsequently captured images could be stored.

As shown in FIG. 6, the image capture modules 152, also referred to as detectors, could include one or more cameras. The image capture modules 152 shown in FIG. 6 is a live active camera (or cameras) placed in the body of the printer with diagnostic system to output to the display screen 124, such as an LCD screen shown, as part of the diagnostic viewing module 122 in communication with the system 100 or remote from the system. The camera can view in the visible spectrum or be a specialized camera that may use filters, such as polarizing or wavelength specific filter, and other optical related devices that are known in the art. For example the use of an infrared (IR) sensitive image capture module to capture invisible or near invisible infrared illumination can be used internally in the printing device to detect localized heat patterns that are not visible with conventional visible light sensitive image capture modules. If pre-stored IR reference images 155 are available changes in heat patterns can be observed indicating a potential failure condition such as a motor operating outside of its normal specifications and overheating.

The diagnostic system 130 may incorporate one or more additional printing error detection references. In one embodiment the references can be used with a single sided media, such as a “Photo grade” media, that includes a watermark on the non-imaging side or with a dual sided media when printing in a duplex mode, allowing the image capture module to determine if the single sided media is in the proper printing orientation by detecting the position of the watermark. If the printer is using dual sided media in duplex mode the image capture module can monitor the printed and blank sides of the media during the printing process to determine if the media is in the proper printing orientation by also detecting the position of the watermark.

Another embodiment of the image modules in the diagnostic system 130 pairs the printing error detection reference with a recording of the “time capture” which can be shown in the video display screen along with other information as shown in FIG. 6. It could be useful in the communication of an event such as when a service person is discussing the first moment when a jamming situation is noticeable. This information could be searchable in a histogram database. For example:
Jamming event started@“1-28-08 01:12:37” Media transport system shut down due to jam “1-28-08 01:12:41”

In FIG. 4 the viewing module 122 allows the user access to a live picture or video in what can be a low-resolution image as seen in the diagnostic area A. The diagnostic area is defined by an angle of view of the image capture device of the image. The embodiment shown in FIG. 6 has four image capture modules 152, each having an angle of view and together forming an angle of view that encompasses one of four printer mechanisms including the feed or supply system 138, the transport belt 128, the printing system 132, the exit roller 150 and the fusing system 146.

The viewer has an active/live preview of the mechanisms in the printer that can be paired with other diagnostic data as discussed above. The diagnostic data collected can be stored and/or compared to other data relevant to the suspected problem or error and displayed in a number of ways including visual icons, histograms of data or even printed out and delivered to a controller via a printer, monitor, cell phone or other communication device and/or user. The printout would contain visuals such as the current image, a histogram, a chart, new maintenance instructions, warnings, supply communications directly to a supplier of consumables, such as toner and other useful and effective means. This view may be low resolution and is representative of the current situation under observation. The collected data does not have to be intended for long-term use, as they can be analyzed and discarded if not representative.

If there is a problem, such as a jam or roller residue (hot offset) in an unknown location, a stream of representative images will flow at a frame rate defined as a number of frames of image per time showing the area of possible concern. The one or more of the image capture modules 152 contain the image detectors and are located in the body of the printer with communication to an external display 124. The printer with diagnostic system unit can be adapted to engage an interface that can be used to convey images and related data to and/or from any imaging device including any electronic device having images stored therein including, but not limited to, cellular phones, personal digital assistants, personal computers, and image players. The image capture modules 152 can include one or more light sources to provide the light energy necessary to illuminate the print mechanisms and supply any light that might be needed by the modules 152. The diagnostic system 130 can include one or more lens for directing light onto the mechanisms as well as one or more mirrors within the system for use in areas such as for guiding reflected light from the paper document trough the lens and onto the imaging module. Image information from diagnostic system 130 is provided to the printer and the print driver as necessary to change the printer operations, such as paper feed speed and appropriate driving and image processing circuits so that corrective action is taken.

### Control Unit

The control unit, also referred to as the controller 128, can control the portions of the system and can include a microprocessor, micro-controller, or any other electronic circuit adapted to govern image scanning, processing, storage and diagnostic sharing processes. The diagnostic system 130 could include one or more sensors 155 to collect information to pass to the control unit 128, also referred to as a controller including a central processing unit, which can be part of a computer or other device. The captured digital images and other related diagnostic information may be stored, transmitted and/or manipulated as desired. Typically, the captured diagnostic information, including images, would be sent to a device for writing the information on to a storage medium for example, a CD or computer disk and the non-archival will be sent to the viewer. Alternatively, the data could be sent to an image storage device, which could be the computer of the owner of the images, a printer for printing of the image, or simply to a long term or temporary storage device or facility. The control unit can include image processing. Having the image processing built into the printer with diagnostic system, as opposed to having the host computer do the image processing, allows for use of dedicated electronic hardware for this function, providing faster processing speeds. The image processing could include, but is not limited to, image enhancements, conversion to a grayscale or a black-and-white image, image skew correction, border removal, background form dropout, and image file compression.

### Print Engine

FIG. 4 also shows the print engine 120 also sometimes referred to as a printer 120. The print engine can record images on receiver medium 136 using a variety of known technologies including conventional four color offset separation printing or other contact printing, silk screening, dry electrophotography such as is used in the NexPress 2100 printer sold by Eastman Kodak Company, Rochester, N.Y., USA, thermal printing technology, drop on demand inkjet technology and continuous inkjet technology. For the purpose of the following discussions, print engine will be described as being of a type that generates color images. However, this is not necessary and the claimed methods and apparatuses can be practiced with a print engine that is adapted to form monotone images such as black and white, grayscale or sepia toned images.
Medium advance is used to position the receiver medium and/or print engine relative to each other to facilitate recording of an image on receiver medium 136.

The controller 128 discussed above can include the processor to perform a number of pre-printing operations, which can include converting digital image data into colors to be printed on receiver medium, determining a printing speed for printing using receiver medium, determining whether an image can be printed using the loaded type or shape of receiver medium, determining whether there is a need to reload the a print medium supply, selecting a dye or colorant set for use in printing using receiver medium and/or any other functions necessary to prepare data and materials for print engine 120 can record an image on receiver medium. Other examples of such pre-printing operations include determining before printing, whether printer 120 has been loaded with a desired type of print medium. Once that the pre-printing operations are complete, control unit 128 can cause print engine 120 and, optionally, receiver medium transport path to operate to record an image on the printable layer using print engine. The printing can include any form of printing known in the art. The controller 128 and processor can also perform a number of correction operations, which can include watching for indications of a potential problem conditions, such as a receiver that has the wrong side up or which is skewed and correct the pre- condition and/or alert a user that corrective actions must be taken. Similarly the controller 128 and processor can recognize and detect current jams and perform a number of corrective operations. Communications can be wired or non-wired as discussed above.

The diagnostic viewing module 108 acts as the user interface with human interface features allowing a user to input information in a way that can be detected by controller 128 and the display 124 allowing the system to provide information to the user. The display 124 can comprise a status indicator such as a visible signal or icon, text messages, or images. In the embodiment shown in FIG. 6, the system can be used to receive signals from controller 128 and to convert these signals into a form that can be used by display 124 to present information to a user. This information includes the real time image of the item 115 on the platen 104 during scanning.

The system 100 also can include memory 156. Memory 156 can include conventional memory devices including solid state, magnetic, optical or other data storage devices. Memory 156 can be fixed within printer 120 or it can be removable. In the embodiment of FIG. 6, memory 156 is shown adjacent the control unit 128. Data, such as control programs, digital images and metadata, can also be stored in a remote memory. The printer 120 can use a communication system 160 for communicating with, for example, remote memory system. Communication system 160 can be, for example, an optical, radio frequency circuit having a transducer and appropriate signal processing circuitry to convert image and other data into a form that can be conveyed to a remote device such as remote memory system by way of an optical signal, radio frequency signal or other form of signal. Communication system 160 can also be used to receive a digital image and other information from a host computer or network. Communication system 160 provides control unit 128 with information and instructions from signals received thereby.

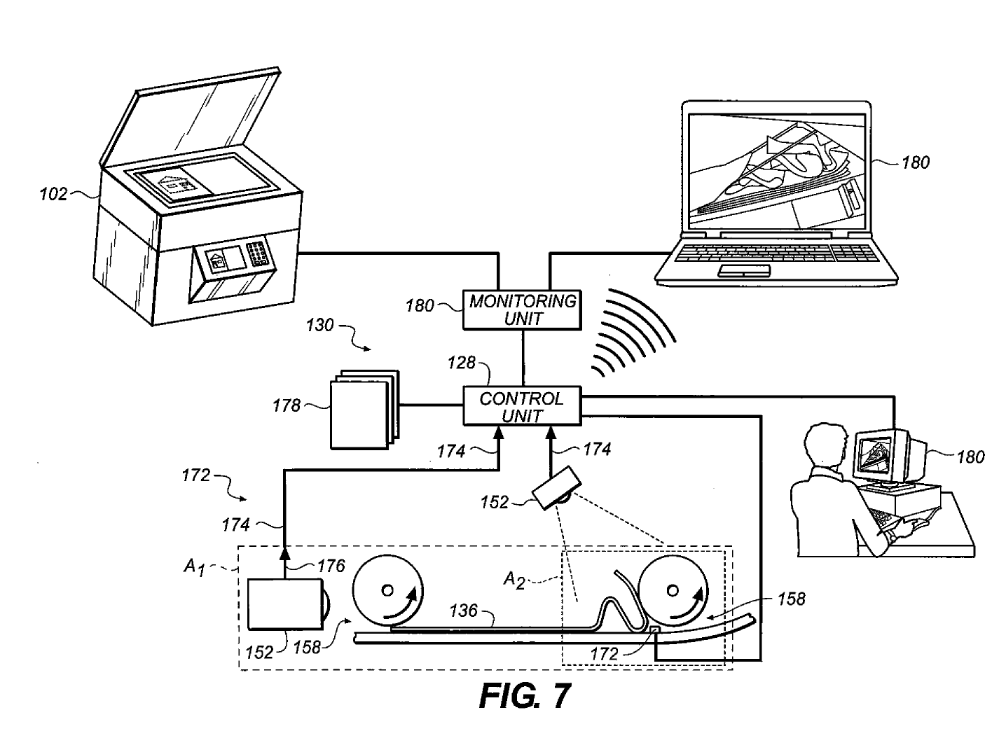

In one embodiment, a portion of which is shown in FIG. 7, the diagnostic system 130 includes one or more print mechanisms 158 in the body 102 with the imaging modules 152 disposed in the body relative to at least one of the print mechanisms 158. The image capture modules 152, as part of a diagnostic system module 172, are disposed in the body facing respective portions of the one or more print mechanisms 158, each the image capture module generating al least one and preferably a stream of images 174 from the image capture modules 152 in order to detect any current conditions or pre-conditions in the system including those in relation to the one or more print mechanisms 158 and ultimately the print job and printer system as a whole. The image capture modules 172 generate an error signal 176 responsive to the media jam, and the control unit 128 receives the streams of images 174 from the image capture modules 152 and optionally the error signal 176 from the printer. In one example the control unit responds to the error signal and generates a log 178 including one of more current images from the one or more streams and/or all streams.

The diagnostic system of this embodiment includes at least two image modules 152, shown here as two cameras that work in conjunction to each other to ensure that the diagnostic viewing area A of each overlaps. Here the first camera is positioned perpendicular to the media 136 relative to a first detection area A₁ so that there is a view of the total sheet feed area on the print path (such as a top or side view) and a second camera is positioned relative to the first camera and parallel to the print mechanism as shown so that the second diagnostic viewing area A₂ covers a part of the first camera's diagnostic viewing area from a different angle for viewing the print mechanism alone and also viewing what the paper path is showing at the same time. This is also referred to as a dual image capture module system 190 for using two or more image capture modules, one essentially perpendicular to the surface of the print media and one essentially perpendicular to at least one of the side edges of the print media.

The log 178 collects representative image sequences from each of a set of image and data streams collected from the image modules 156. The system uses a plurality of user-variable and/or table stored operating parameters along with the log and current values and information associated with the user-variable operating parameters, supplied as metadata associated with respective the images, to detect and correct the problem, such as a jam. Examples of user-variable operating parameters, such as temperature and humidity as well as paper type, printer mode and past information but could include any of the parameters the system and/or user monitors. The print mechanisms can include a recirculating feeder and another of the print mechanisms is a receiver transport. Note that if there are multiple image capture modules then the image capture modules can be interchangeable with each other.

The one or more print mechanisms are subject to media jams in a plurality of locations in the printing system and the control unit includes an artificial intelligence component capable of generating one of a plurality of different remedial signals responsive to the error signal and the log. These artificial intelligence component includes one of more of the following, individually or in any combination: rule-based systems, theorem proving systems, semantic knowledge network approaches, frame-based knowledge systems, neural networks, fuzzy-logic based systems, genetic algorithm mechanisms; and heuristic-based systems.

A monitoring unit 180 can be wired or wireless and may be remote in some embodiments and include a first telecommunications interface, and wherein the printing system further includes a second telecommunications interface mounted to the body, the telecommunications interfaces being operatively connectable. The control and monitoring units are configured in an embodiment to selectively upload and display the log on the monitoring unit and the telecommunications interfaces each include voice communications capabilities as well as to selectively upload and display each of the streams on the monitoring unit.

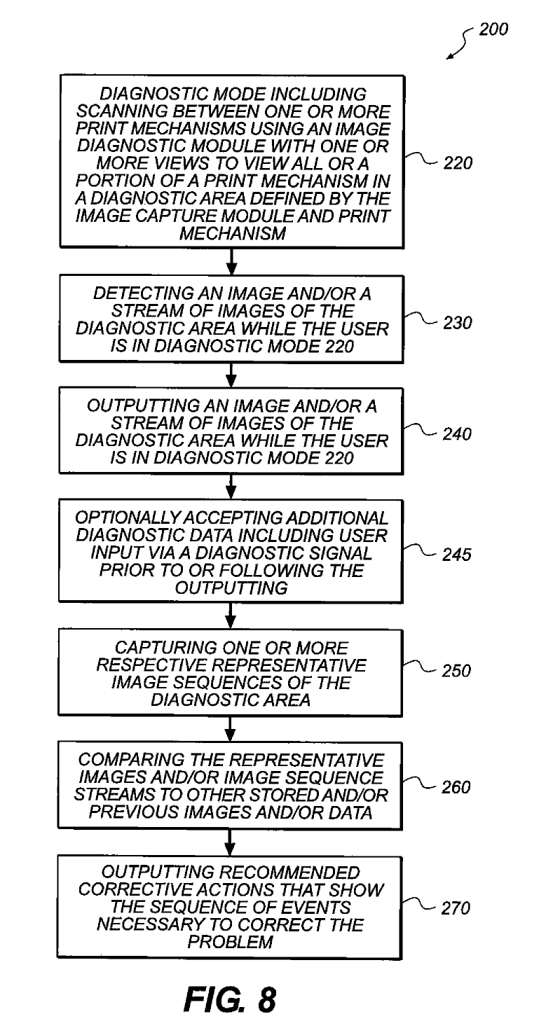

The scanning modules 200 being actuatable to scan the mechanisms while the capturing the archival image of the diagnostic area that can be continual or initiated as needed, such as when a valuable document is being scanned by generating an error signal from the image capture modules 152. When the error signal is received it can be added to a log of error signals to be used by the controller and/or user to optimize operations and minimize future e problems such as jams. The image capture modules 152 allows the user to actually see the condition and/or problem real time as well as the conditions that lead to the problem and thus easily initiate corrective actions. A diagnostic method 200 as shown in FIG. 8 is used including the steps of diagnostic mode 220 including scanning between one or more print mechanisms using a image diagnostic module with one or more views to view all or a portion of a print mechanism in a diagnostic area defined by the image capture module and print mechanism. Then detecting 230 and outputting 240 an image and/or a stream of images of the diagnostic area while the user is in diagnostic mode 220. Optionally accepting 245 additional diagnostic data including user input via a diagnostic signal prior to or following the outputting. Further including capturing 250 one or more respective representative image sequences of the diagnostic area and comparing 260 the representative images and/or image sequence streams to other stored and/or previous images and/or data before outputting recommended corrective actions 270 that show the sequence of events necessary to correct the problem.

As discussed above the one or more image capture modules 152 are mounted in the body in fixed relation to the diagnostic area in the embodiment but could also move. The one or more image capture modules are operative to capture a stream of representative images of the diagnostic area. Each image capture module can include an area array imager such that the one or more image capture modules are operative to output a stream of representative images of the diagnostic area facing the diagnostic area.

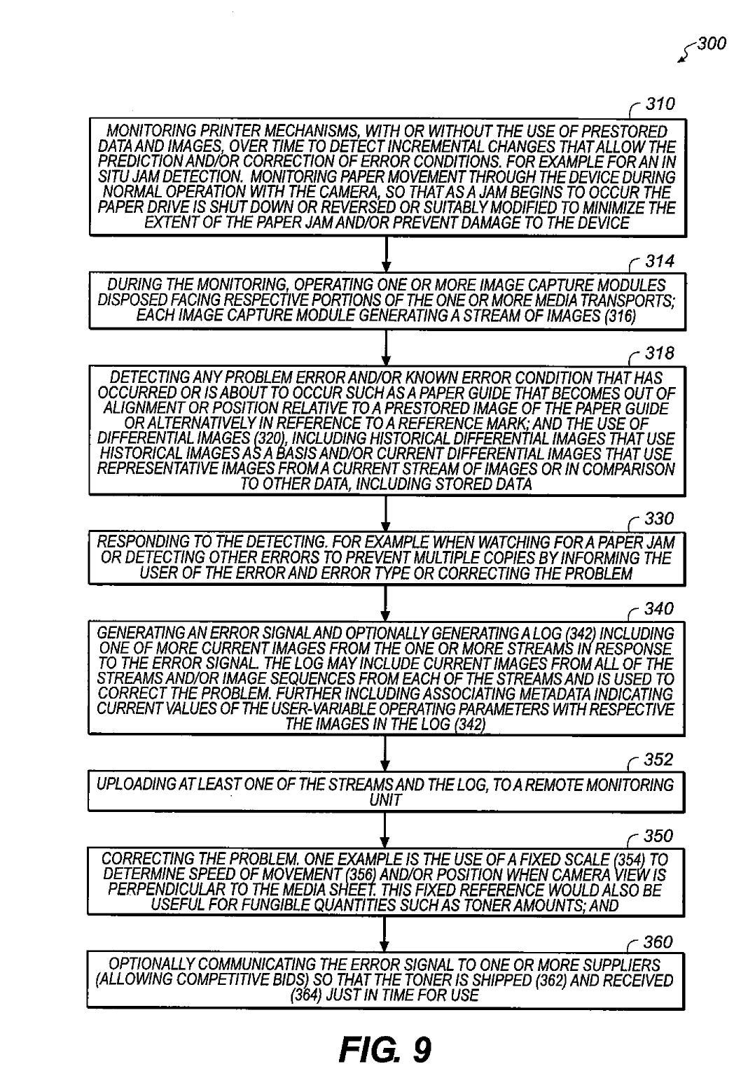

The diagnostic system and associated method shown in FIG. 9 is used when a problem is detected or predicted in most situations but would be applicable to any problem that can be aided by a visual inspection and/or log as supplied by one or more image capture modules 152. The diagnostic method 300 of FIG. 9 includes the steps of monitoring 310 printer mechanisms, with or without the use of prestored data and images, overtime to detect incremental changes that allow the prediction and/or correction of error conditions, also referred to as problems, in a printing system including the use of prestored data. The prestored data includes images that could have been captured by the image module can enhance the ability to automatically determine that an error and/or know error condition has occurred or is about to occur. For example the view of the mechanism, such as a paper guide, that becomes out of alignment or position relative to a prestored image of the paper guide. Alternatively the prestored reference could be a reference mark. An example of an in situ jam detection application involves monitoring paper movement through the device during normal operation with the camera, as a jam begins to occur (e.g. paper edge and/or surface begins to deform from its rectilinear and/or roller conformant shape) then the paper drive is shut down or reversed or suitably modified to minimize the extent of the paper jam and/or prevent damage to the device. During the monitoring, operating 314 one or more image capture modules are disposed facing respective portions of the one or more media transports, each the image capture module generating 316 a stream of images.

During the monitoring the diagnostic system will detect 318 any problem error and/or know error condition that has occurred or is about to occur such as a paper guide that becomes out of alignment or position relative to a prestored image of the paper guide or alternatively in reference to a reference mark. The use of differential images 320, including historical differential images that use historical images as a basis and/or current differential images that use representative images from a current stream of images or in comparison to other data, including stored data. Then the system will respond 330 to the problem. For example when watching for a paper jam or detecting other printing, media, layout, fusing errors in order to prevent multiple error copies from being made by informing the user of the error and error type or correcting the problem as discussed below.

When the system responds it generates an error signal 340 and optionally generates a log 342 that includes one of more current images from the one or more streams in response to the error signal. The log may include current images from all of the streams and/or image sequences from each of the streams and is used to correct the problem. The system also is used to correct the problem during a correcting step 350. For example for an in situ jam detection when monitoring paper movement through the device during normal operation with the camera as a jam begins to occur (e.g. paper edge and/or surface begins to deform from its rectilinear and/or roller conformant shape) the paper drive is shut down or reversed or suitably modified to minimize the extent of the paper jam and/or prevent damage to the device. This could use the dual image module with the first camera imaging the whole paper path for instance from a top view or a side view such that the whole paper path is seen and using a second camera to view one mechanism and compare that view to the one of the first camera.

The system can further include associating metadata indicating current values of the user-variable operating parameters with respective the images in the log 342 and uploading 352 at least one of the streams and the log, to a remote monitoring unit. Also including using reference marks (graphic dots, arrows, lines etc of known colors, sizes or shapes to determine precise locations of printing mechanisms and individual components in optimal position (operating at peak). These indicator marks could include lines on a scale along the media path to more precisely determine the position in which the media itself has ceased to move to determine the position in which the media itself has ceased to move. Similarly the use of a special reference “document”, such as a target on a sheet of media printed by the device, used to enhance the detection of movement. One example is the use of a fixed scale 354 to determine speed of movement 356 and/or position when camera view is perpendicular to the media sheet. This fixed reference would also be useful for fungible quantities such as toner amounts and the error signal could be communicated 360 to one or more suppliers (allowing competitive bids) and the toner shipped 362 and received just in time for use 364.

The use of various monitoring modes include a diagnostic mode, a control mode a watch while testing mode, an initiating service procedure mode, an initiate service of whole or parts of the printer mode, and all modes could have different sub modes allowing slow or fast, detailed or general image collection. Foe example the representative images cold be collected for 10 seconds every minute and be a slow motion steam of video that was matched against stored images from a day before at the same time of capture.

The invention has been described in detail with particular reference to certain preferred embodiments thereof, but it will be understood that variations and modifications can be effected within the spirit and scope of the invention.

1. A printing system comprising:
a body;
one or more print mechanisms disposed in said body wherein a diagnostic area corresponds to an area around said print mechanism;
a print engine disposed in said body in operative relation to at least one of said print mechanisms;
one or more image capture modules disposed in said body facing respective portions of said one or more diagnostic areas, each said image capture module capable of selectively generating a stream of images to memory,
a image capture controller for controlling said image capture modules in relation to predetermined references; and
a control unit responsive to a control signal for initiating operation of said image capture modules in relation to said references using said image capture controller to deliver said video combined with diagnostic information at a rate commensurate with normal operation of the printing system to said temporary memory.

2. The apparatus of claim 1, said control unit generating an error signal when detecting any problem in said one or more print mechanisms, and said control unit, responsive to said error signal, generating a log including one of more current images from said one or more streams.

3. The apparatus of claim 1, wherein said control unit comprising a digital processor includes interrupting said digital processor.

4. The apparatus of claim 1 further including a visual indicator wherein said control unit activates said visual indicator according to the state of said printing system.

5. The apparatus of claim 1 said diagnostic information further comprising data comprising one or more of the following in data: temperature, printer mode, user, receiver type, stored data, stored diagnostic images and current images.

6. The apparatus of claim 1 further comprising differential images.

7. The apparatus of claim 1 in which said diagnostic system comprising an output system to send resultant instructions.

8. The apparatus of claim 1, the digital processor further comprising diagnostic operations for operating on blocks of stored video at a processing throughput rate different [faster or slower] than said input rate, said digital processor for transforming blocks of video into corresponding compressed stream of video signals including diagnostic controller for monitoring the utilization of said video whereby information is generated as to the current condition of the printer.

9. The apparatus of claim 1, wherein the image capture modules comprises an infrared (IR) camera.

10. The apparatus of claim 1, wherein the predetermined references comprise a stored image corresponding to the diagnostic area and mechanism.

11. The apparatus of claim 1, wherein the predetermined references comprise reference marks.

12 The apparatus of claim 11, wherein the reference marks comprises lines on a scale along the media path and a target reference.

13. The apparatus of claim 1, wherein the image capture modules comprises two or more cameras positioned relative to a diagnostic area so that one camera is substantially perpendicular to the media sheet viewing the print path and one is substantially parallel to the print mechanism for viewing the print mechanism alone.

14. A diagnostic printing system comprising:
a body,
one or more print mechanisms disposed in said body wherein a diagnostic area corresponds to an area around said print mechanism;
a mechanism controller disposed in said body in operative relation to at least one of said print mechanisms;
one or more image capture modules disposed in said body facing respective portions of said one or more diagnostic areas, each said image capture module capable of selectively generating a stream of images to memory;
a image capture controller for controlling said image capture modules in relation to predetermined references; and
a control unit responsive to a control signal for initiating operation of said image capture modules in relation to said references using said image capture controller to deliver said video combined with diagnostic information at a rate commensurate with normal operation of the printing system to said temporary memory.

15. The apparatus of claim 14, further comprising a printer shutdown responsive to the diagnostic printing system.

16. The apparatus of claim 14, further comprising output including an updated maintenance schedule.

17. The apparatus of claim 14, further comprising output including a histogram with diagnostic information.

18. A printing method comprising the steps of:
scanning between one or more print mechanisms using a image diagnostic module with one or more views to view all or a portion of a print mechanism in a diagnostic area defined by the image capture module and print mechanism;
detecting and outputting one or more representative images of the diagnostic area;
comparing the representative images to other stored data; and
responsive to said comparing step, generating output including one of more current images from said one or more image diagnostic modules.

19. The method of claim 18, wherein said output comprises a log including current data.

20. The method of claim 18, wherein said generating further comprises associating metadata indicating current values of said user-variable operating parameters with respective said images in said log.

21. The method of claim 18 further comprising uploading at least one of: said images and said stored data, to a remote monitoring unit.

22. The method of claim 18, wherein said detecting further comprises differential images.

23. The method of claim 18, wherein said detecting uses one or more references.

24. The method of claim 18, wherein said generating further comprises corrective actions.

25. The method of claim 24, wherein said corrective actions further comprises premeditated actions.
